(19) United States
(12) Patent Application Publication
(10) Pub. No.: US 2006/0078781 A1
(43) Pub. Date: Apr. 13, 2006

(54) Curable subgasket for a membrane electrode assembly

(75) Inventors: David W. Stegink, Mendota Heights, MN (US); David R. Mekala, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/961,263

(22) Filed: Oct. 8, 2004

(51) Int. Cl. H01M 2/08; H01M 8/10; H01M 4/94; B05D 5/12

(52) U.S. Cl. 429/35; 429/36; 429/30; 429/44; 427/115

(57) ABSTRACT

A subgasket for a membrane electrode assembly is deposited on a surface of a MEA component and cured in situ. A membrane electrode subassembly includes a polymer electrolyte membrane, a gas diffusion layer and a catalyst layer between the polymer electrolyte membrane and the gas diffusion layer. The membrane electrode subassembly includes a subgasket, disposed over one or more components of the membrane electrode subassembly. The subgasket is made of a layer of material that is depositable and curable in situ. A peripheral edge of the gas diffusion layer overlaps the subgasket.

### FIELD OF THE INVENTION

The present invention relates generally to fuel cells and, more particularly, to a curable subgasket for a membrane electrode assembly.

### BACKGROUND OF THE INVENTION

A typical fuel cell power system includes a power section in which one or more stacks of fuel cells are provided. The efficacy of the fuel cell power system depends in large part on the integrity of the various contacting and sealing interfaces within individual fuel cells and between adjacent fuel cells of the stack.

Presently, the process of building a stack of fuel cells using conventional approaches is tedious, time-consuming, and not readily adaptable for mass production. By way of example, a typical 5 kW fuel cell stack can include some 80 membrane electrode assemblies (MEAs), some 160 flow field plates, and some 160 sealing gaskets. These and other components of the stack must be carefully aligned and assembled. Misalignment of even a few components can lead to gas leakage, hydrogen crossover, and performance/durability deterioration.

The durability of the fuel cell membrane during extended operation often determines whether fuel cells can be used cost effectively. Although an MEA can fail in a number of ways, MEAs are typically taken out of service with gas crossover exceeds a certain rate, indicating the membrane has been punctured mechanically or eroded in thickness due to chemical decay.

There is a need for an MEA having an improved durability and lifetime. The present invention fulfills these and other needs.

### SUMMARY OF THE INVENTION

The present invention is directed to a curable subgasket for a membrane electrode assembly. An embodiment of the invention is directed to a structure for a membrane electrode assembly (MEA). The MEA structure includes a membrane electrode subassembly including a polymer electrolyte membrane, a gas diffusion layer and a catalyst layer between the polymer electrolyte membrane and the gas diffusion layer. The membrane electrode subassembly includes a subgasket, disposed over one or more components of the membrane electrode subassembly. The subgasket is made of a layer of material that is depositable and curable in situ. A peripheral edge of the gas diffusion layer overlaps the subgasket.

The subgasket may be disposed over a peripheral portion of the polymer electrolyte membrane. In some configurations, a portion of the subgasket may be disposed between the catalyst layer and the polymer electrolyte membrane or between the catalyst layer and the gas diffusion layer. Alternatively, a subgasket layer may be disposed over a peripheral portion of the gas diffusion layer.

In some implementations, the gas diffusion layer and the catalyst layer form a catalyst coated electrode backing. An edge of the catalyst coated electrode backing overlaps the subgasket. In other implementations, the polymer electrolyte membrane and the catalyst layer form a catalyst coated membrane. The subgasket may be disposed over a peripheral portion of the catalyst coated membrane.

Another embodiment of the invention involves a membrane electrode assembly (MEA) having first and second membrane electrode structures coupled together. At least one of the first and second membrane electrode structures include an electrode subassembly comprising a polymer electrolyte membrane, a gas diffusion layer, and a catalyst layer between the polymer electrolyte membrane and the gas diffusion layer. A subgasket is disposed over one or more components of the electrode subassembly. The subgasket is made a layer of material that is depositable and curable in situ. The subgasket is positioned so that a peripheral edge of the gas diffusion layer overlaps the subgasket.

According to one aspect of the invention the first and second membrane electrode structures are coupled by a fused bilayer polymer electrolyte membrane.

Yet another embodiment of the invention is directed to an electrochemical cell assembly. The electrochemical cell assembly includes a membrane electrode assembly (MEA) having a subgasket layer. The MEA includes a polymer electrolyte membrane, first and second gas diffusion layers disposed at opposite surfaces of the polymer electrolyte membrane, and first and second catalyst layers respectively disposed between the first and second gas diffusion layers and the polymer electrolyte membrane. The subgasket layer is formed of a material that is depositable and curable in situ. A portion of the subgasket layer is disposed between first and second gas diffusion layers of the MEA.

A further embodiment of the invention involves a method for making a membrane electrode assembly (MEA). The method includes forming one or more subgasketed MEA components. The subgasketed MEA components are formed by depositing a dispersable subgasket material over a portion of at least one surface of one or more MEA components. The subgasket dispersion material is cured in situ to form one or more subgasket layers. First and second gas diffusion layer (GDL) structures are aligned at opposite surfaces of a polymer electrolyte membrane (PEM) structure so that portions of the subgasket layers are disposed between the first and the second GDL structures. One or more of the first GDL structure, the second GDL structure and the PEM structure comprises the one or more subgasketed MEA components.

Yet another embodiment of the invention involves a method for making a membrane electrode subassembly that includes a gas diffusion layer structure and a polymer electrolyte membrane structure. The method includes forming a subgasketed MEA component. The subgasketed MEA component is formed by depositing a dispersable subgasket material over a portion of at least one surface of an MEA component. The subgasket dispersion material is cured in situ to form one or more subgasket layers. The GDL structure is disposed over the PEM structure so that an edge of the GDL structure overlaps a portion of the one or more subgasket layers. At least one of the GDL and the PEM comprise the one or more subgasketed MEA components.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1A is an illustration of a fuel cell and its constituent layers;

FIG. 1B illustrates a unitized cell assembly having a monopolar configuration in accordance with an embodiment of the present invention;

FIG. 1C illustrates a unitized cell assembly having a monopolar/bipolar configuration in accordance with an embodiment of the present invention;

FIG. 2A illustrates a cross sectional view of a catalyst coated electrode backing (CCEB) based membrane electrode assembly (MEA) structure;

FIG. 2B illustrates a cross sectional view of a catalyst coated membrane (CCM) based MEA structure;

FIG. 2C is a cross section of a CCEB based MEA having subgasket layers in accordance with embodiments of the invention;

FIG. 2D illustrates a cross section of a CCM-based MEA where edges of gas diffusion layer (GDL) structures overlap subgasket layers in accordance with embodiments of the invention;

FIG. 2E illustrates a CCM-based MEA cross-section having GDL structures that overlap the subgaskets such that the perimeters of the GDL structures do not directly contact the CCM in accordance with embodiments of the invention;

FIG. 3A shows a cross-sectional view of a CCEB-based MEA sub-assembly (or ½-MEA) in accordance with embodiments of the invention;

FIG. 3B illustrates a cross sectional detail of two ½-MEA sub-assemblies, bonded together in accordance with embodiments of the invention;

FIG. 3C shows cross sectional view of a CCM-based sub-assembly (½-MEA structure) having a GDL that overlaps the protective subgasket in accordance with embodiments of the invention;

FIG. 3D illustrates a cross sectional view of two CCM sub-assemblies bonded together to form an MEA structure in accordance with embodiments of the invention;

FIG. 3E depicts a cross section of a CCM-based ½-MEA sub-assembly in accordance with embodiments of the invention;

FIG. 3F illustrates the fusion of two CCM-based ½-MEA sub-assemblies in accordance with embodiments of the invention;

FIG. 4A illustrates a ½-MEA subassembly having a subgasket layer that reinforces the perimeter region of a PEM in accordance with embodiments of the invention;

FIG. 4B illustrates two ½-MEA subassemblies prior to fusing, the ½-MEAs having subgasket layers disposed on the backside of fusible membranes in accordance with embodiments of the invention;

FIG. 4C illustrates a cross section of a CCEB-based MEA assembly having protective subgasket layers applied to the backside of PEMs in accordance with embodiments of the invention;

FIG. 4D illustrates a cross sectional view of a CCM-based MEA sub-assembly (½-MEA) having protective subgasket layers applied to the backside of the membrane in accordance with embodiments of the invention;

FIG. 4E illustrates two CCM sub-assemblies that could be laminated together to form a bilayer membrane in accordance with embodiments of the invention;

FIG. 4F illustrates cross section of a full MEA having a bilayer membrane 450 with an internal subgasket layers forming a reinforced edge in accordance with embodiments of the invention;

FIG. 5 illustrates a cross section of a CCM-based MEA having protective subgasket layers disposed on peripheral portions of the GDLs accordance with embodiments of the invention;

FIGS. 6 and 7 are flowcharts illustrating processes involved in making MEA assemblies and subassemblies in accordance with embodiments of the invention;

FIG. 8 is an illustrative depiction of a simplified fuel cell stack that facilitates an understanding of the manner in which fuels pass into and out of a stack of fuel cells, wherein the fuel cells preferably utilize MEA assemblies in accordance with the principles of the present invention; and

FIGS. 9-12 illustrate various fuel cell systems that may incorporate the MEA assemblies described herein and use a fuel cell stack for power generation.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

The present invention is directed to a protective subgasket formed between layers of a membrane electrode assembly (MEA). Certain embodiments are directed to a full MEA assembly having subgaskets respectively disposed between the electrolyte membrane and the first and second GDL layers. In other implementations, a ½ MEA assembly is provided with a subgasket disposed between the PEM and a GDL layer. Further embodiments of the present invention are directed to fuel cell stacks and systems implemented using subgasketed MEA assemblies.

A fuel cell is an electrochemical device that combines hydrogen fuel and oxygen from the air to produce electricity, heat, and water. Fuel cells do not utilize combustion, and as such, fuel cells produce little if any hazardous effluents. Fuel cells convert hydrogen fuel and oxygen directly into electricity, and can be operated at much higher efficiencies than internal combustion electric generators, for example.

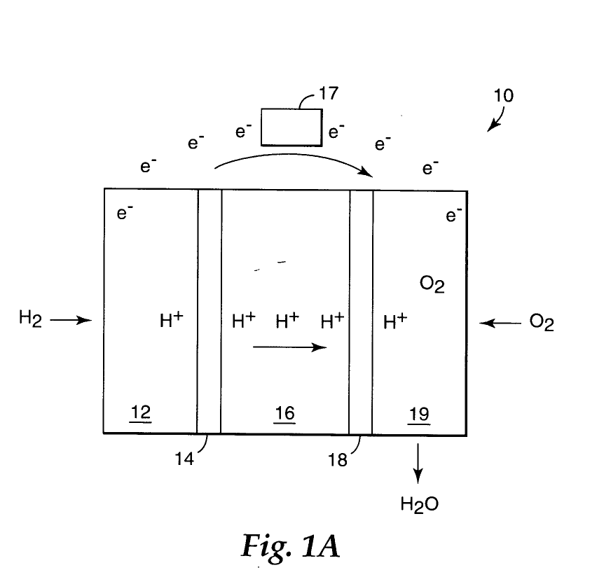

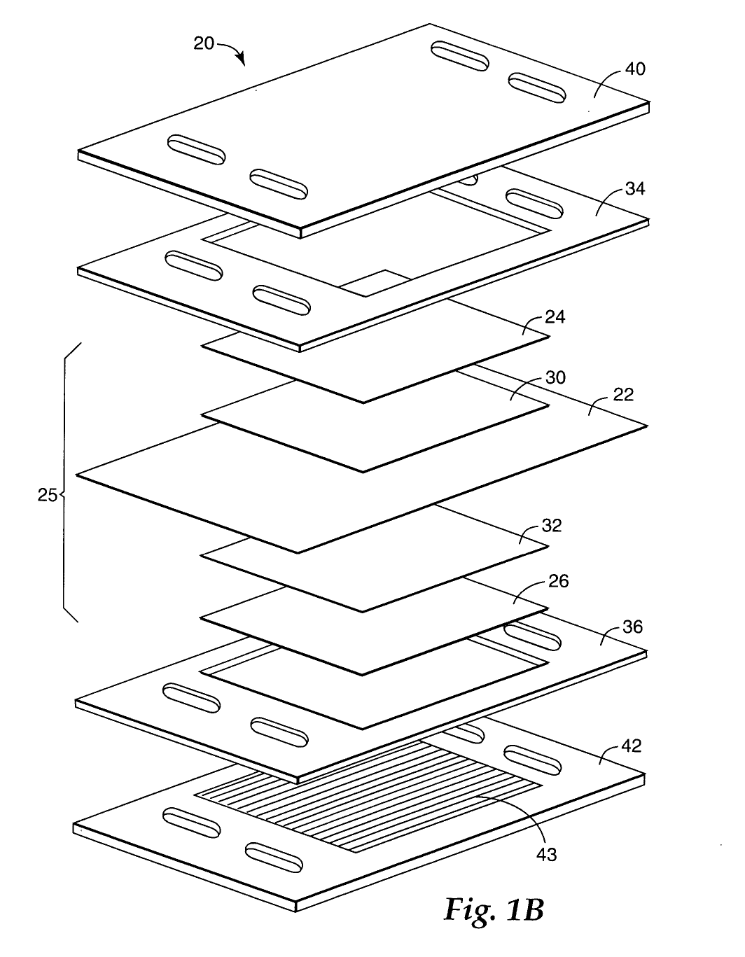

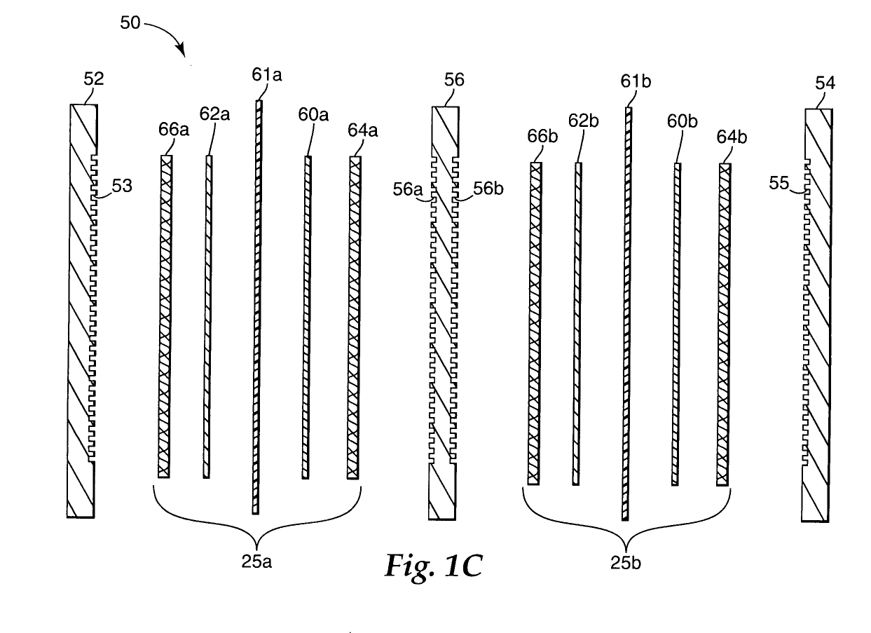

A typical fuel cell is depicted in FIG. 1A. The fuel cell 10 shown in FIG. 1A includes a first gas diffusion layer (GDL) 12 adjacent a gas diffusion microlayer comprising an anode 14. Adjacent the anode 14 is an electrolyte membrane 16. A gas diffusion microlayer cathode 18 is situated adjacent the electrolyte membrane 16, and a second gas diffusion layer 19 is situated adjacent the cathode 18. In operation, hydrogen fuel is introduced into the anode portion of the fuel cell 10, passing through the first gas diffusion layer 12 and over the anode 14. At the anode 14, the hydrogen fuel is separated into hydrogen ions (H⁺) and electrons (e⁻).

The electrolyte membrane 16 permits only the hydrogen ions or protons to pass through the electrolyte membrane 16 to the cathode portion of the fuel cell 10. The electrons cannot pass through the electrolyte membrane 16 and, instead, flow through an external electrical circuit in the form of electric current. This current can power an electric load 17, such as an electric motor, or be directed to an energy storage device, such as a rechargeable battery.

Oxygen flows into the cathode side of the fuel cell 10 via the second gas diffusion layer 19. As the oxygen passes over the cathode 18, oxygen, protons, and electrons combine to produce water and heat.

Individual fuel cells, such as that shown in FIG. 1A, can be packaged as unitized fuel cell assemblies. The unitized fuel cell assemblies, referred to herein as unitized cell assemblies or UCAs for convenience, can be combined with a number of other UCAs to form a fuel cell stack. The number of UCAs within the stack determines the total voltage of the stack, and the active surface area of each of the cells determines the total current. The total electrical power generated by a given fuel cell stack can be determined by multiplying the total stack voltage by total current.

A number of different fuel cell technologies can be employed to construct UCAs in accordance with the principles of the present invention. For example, a UCA packaging methodology of the present invention can be employed to construct proton exchange membrane (PEM) fuel cell assemblies. PEM fuel cells operate at relatively low temperatures (about 175° F./80° C.), have high power density, can vary their output quickly to meet shifts in power demand, and are well suited for applications where quick startup is required, such as in automobiles for example.

The proton exchange membrane used in a PEM fuel cell is typically a thin plastic sheet that allows hydrogen ions to pass through it. The membrane may be coated with a catalyst layer, such as a layer of highly dispersed metal or metal alloy particles (e.g., platinum or platinum/ruthenium). The electrolyte used is typically a solid organic polymer such as poly-perfluorosulfonic acid. Use of a solid electrolyte is advantageous because it reduces corrosion and management problems. In some configurations, the electrode layer of the GDL may be coated with the catalyst rather than the PEM, forming a structure that is referred to as a catalyst coated electrode backing (CCEB).

Hydrogen is fed to the anode side of the fuel cell where the catalyst promotes the hydrogen atoms to release electrons and become hydrogen ions (protons). The electrons travel in the form of an electric current that can be utilized before it returns to the cathode side of the fuel cell where oxygen has been introduced. At the same time, the protons diffuse through the membrane to the cathode, where the hydrogen ions are recombined and reacted with oxygen to produce water.

A membrane electrode assembly (MEA) is the central element of PEM fuel cells, such as hydrogen fuel cells. As discussed above, typical MEAs comprise a polymer electrolyte membrane (PEM) (also known as an ion conductive membrane (ICM)), which functions as a solid electrolyte.

One face of the PEM is in contact with an anode electrode layer and the opposite face is in contact with a cathode electrode layer. Each electrode layer may include electrochemical catalysts, typically including platinum metal. Gas diffusion layers (GDLs) facilitate gas transport to and from the anode and cathode electrode materials and conduct electrical current.

In a typical PEM fuel cell, protons are formed at the anode via hydrogen oxidation and transported to the cathode to react with oxygen, allowing electrical current to flow in an external circuit connecting the electrodes. The GDL may also be called a fluid transport layer (FTL) or a diffuser/current collector (DCC).

Any suitable PEM may be used in the practice of the present invention. The PEM typically has a thickness of less than 50 μm, more typically less than 40 μm more typically less than 30 μm, and most typically about 25 μm. The PEM is typically comprised of a polymer electrolyte that is an acid-functional fluoropolymer, such as Nafion® (DuPont Chemicals, Wilmington Del.) and Flemion® (Asahi Glass Co. Ltd., Tokyo, Japan) or a polymer having a highly fluorinated backbone and recurring pendant groups according to the formula: YOSO₂—CF₂—CF₂—CF₂—CF₂—O—[polymer backbone]. The latter is disclosed in commonly owned U.S. patent application Ser. No. 10/325,278, filed Dec. 19, 2002, and incorporated herein by reference. The polymer electrolytes useful in the present invention are preferably copolymers of tetrafluoroethylene and one or more fluorinated, acid-functional comonomers.

Typically, the polymer electrolyte bears sulfonate functional groups. Most typically, the polymer electrolyte is a polymer having a highly fluorinated backbone and recurring pendant groups according to the formula: YOSO₂—CF₂—CF₂—CF₂—CF₂—O—[polymer backbone] as disclosed in previously incorporated U.S. patent application Ser. No. 10/325,278. The polymer electrolyte typically has an acid equivalent weight of 1200 or less, more typically 1100 or less, more typically 1050 or less, and most typically about 1000.

Any suitable GDL may be used in the practice of the present invention. Typically, the GDL is comprised of sheet material comprising carbon fibers. The GDL is typically a carbon fiber construction selected from woven and non-woven carbon fiber constructions. Carbon fiber constructions which may be useful in the practice of the present invention may include: Toray Carbon Paper, SPECTRACARB Carbon Paper, AFN non-woven carbon cloth, ZOLTEK Carbon Cloth, and the like. The GDL may be coated or impregnated with various materials, including carbon particle coatings, hydrophilizing treatments, and hydrophobizing treatments such as coating with polytetrafluoroethylene (PTFE).

Any suitable catalyst may be used in the practice of the present invention. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode. The catalyst is typically applied to the PEM or to the GDL in the form of a catalyst ink. The catalyst ink typically comprises polymer electrolyte material, which may or may not be the same polymer electrolyte material that comprises the PEM.

The catalyst ink typically comprises a dispersion of catalyst particles in a dispersion of the polymer electrolyte. The ink typically contains 5-30% solids (i.e. polymer and catalyst) and more typically 10-20% solids. The electrolyte dispersion is typically an aqueous dispersion, which may additionally contain alcohols, polyalcohols, such a glycerin and ethylene glycol, or other solvents such as N-methylpyrilidon (NMP) and dimethyoformahyde (DMF). The water, alcohol, and polyalcohol content may be adjusted to alter Theological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

The catalyst may be applied to the PEM or the GDL by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Direct methanol fuel cells (DMFC) are similar to PEM cells in that they both use a polymer membrane as the electrolyte. In a DMFC, however, the anode catalyst itself draws the hydrogen from liquid methanol fuel, eliminating the need for a fuel reformer. DMFCs typically operate at a temperature between 120-190° F./49-88° C. A direct methanol fuel cell can be subject to UCA packaging in accordance with the principles of the present invention.

Referring now to FIG. 1B, there is illustrated an embodiment of a UCA implemented in accordance with a PEM fuel cell technology. As is shown in FIG. 1B, a membrane electrode assembly (MEA) 25 of the UCA 20 includes five component layers. A PEM layer 22 is sandwiched between a pair of gas diffusion layers 24 and 26. An anode layer 30 is situated between a first GDL 24 and the membrane 22, and a cathode layer 32 is situated between the membrane 22 and a second GDL 26.

In one configuration, a PEM layer 22 is fabricated to include an anode catalyst coating on one surface and a cathode catalyst coating on the other surface. This structure is often referred to as a catalyst-coated membrane or CCM. According to another configuration, gas diffusion layers 24 and 26 are fabricated to include anode and cathode catalyst coatings 30 and 32. This structure is referred to as a catalyst coated electrode backing or CCEB. In yet another configuration, an anode catalyst coating 30 can be disposed partially on the first GDL 24 and partially on one surface of the PEM 22, and a cathode catalyst coating 32 can be disposed partially on the second GDL 26 and partially on the other surface of the PEM 22.

The GDLs 24, 26 are typically fabricated from a carbon fiber paper or non-woven material or woven cloth. Depending on the product construction, the GDLs 24, 26 can have carbon particle coatings on one side. The GDLs 24, 26, as discussed above, can be fabricated to include or exclude a catalyst coating.

In the particular embodiment shown in FIG. 1B, MEA 25 is shown sandwiched between a first edge seal system 34 and a second edge seal system 36. Adjacent the first and second edge seal systems 34 and 36 are flow field plates 40 and 42, respectively. Each of the flow field plates 40, 42 includes a field of gas flow channels 43 and ports through which hydrogen and oxygen feed fuels pass. In the configuration depicted in FIG. 1B, flow field plates 40, 42 are configured as monopolar flow field plates, in which a single MEA 25 is sandwiched there between.

The edge seal systems 34, 36 provide the necessary sealing within the UCA package to isolate the various fluid (gas/liquid) transport and reaction regions from contaminating one another and from inappropriately exiting the UCA 20, and may further provide for electrical isolation and compression control between the flow field plates 40, 42.

In one configuration, the edge seal systems 34, 36 include a gasket system formed from an elastomeric material. In various configurations, as will be described below, one, two or more layers of various selected materials can be deposited and cured in-situ to provide a subgasket for sealing within UCA 20.

FIG. 1C illustrates a UCA 50 that incorporates multiple MEAs 25 through employment of one or more bipolar flow field plates 56. In the configuration shown in FIG. 1C, UCA 50 incorporates two MEAs 25a and 25b and a single bipolar flow field plate 56. MEA 25a includes a gas diffusion microlayer cathode 62a/membrane 61a/gas diffusion microlayer anode 60a layered structure sandwiched between GDLs 66a and 64a. GDL 66a is situated adjacent a flow field end plate 52, which is configured as a monopolar flow field plate. GDL 64a is situated adjacent a first flow field surface 56a of bipolar flow field plate 56.

Similarly, MEA 25b includes a gas diffusion microlayer cathode 62b/membrane 61b/gas diffusion layer anode 60b layered structure sandwiched between GDLs 66b and 64b. GDL 64b is situated adjacent a flow field end plate 54, which is configured as a monopolar flow field plate. GDL 66b is situated adjacent a second flow field surface 56b of bipolar flow field plate 56. It will be appreciated that N number of MEAs 25 and N−1 bipolar flow field plates 56 can be incorporated into a single UCA 50. It is believed, however, that, in general, a UCA 50 incorporating one or two MEAs 56 (N=1, bipolar plates=0 or N=2, bipolar plates=1) is preferred for more efficient thermal management.

The UCA configurations shown in FIGS. 1B and 1C are representative of two particular arrangements that can be implemented for use in the context of the present invention. These two arrangements are provided for illustrative purposes only, and are not intended to represent all possible configurations coming within the scope of the present invention. Rather, FIGS. 1B and 1C are intended to illustrate various components that can be selectively incorporated into a unitized fuel cell assembly comprising MEA's made in accordance with the principles of the present invention.

Embodiments of the invention are directed to a protective subgasket for PEM type fuel cell membrane electrode assemblies and subassemblies. The subgasket serves to both seal the MEA to reduce leakage and to protect the PEM from damage. The surface of the subgasket may comprise a microstructured or tacky surface to enhance sealing of the MEA. In some embodiments, the subgasket material may comprise a pressure sensitive adhesive composition.

Microscopic examination of failed MEAs reveals that holes or tears in the membrane at the MEA perimeter are common. The damage is often caused by stresses and wrinkling of the membrane at the perimeter interface between the membrane and the GDL. GDL's are typically prepared from fibrous carbon, which tends to gouge the membrane where fibers are in contact with the membrane. The subgasket of the present invention may be employed to reduce mechanical failures of the fuel cell membrane, for example, at the edges of the active area or at the edges of the GDL. According to embodiments of the invention, a protective layer subgasket is deposited between the membrane and the GDL and is cured in place, providing a needed rugged interface that reduces membrane damage along the perimeter interface. An associated feature of the subgasket is that the membrane (which is hygroscopic) is coated and thus protected from moisture.

The subgasket enhances the stability of the membrane, reducing wrinkling of the membrane at the MEA perimeter. Wrinkles of the membrane, particularly when they occur at the GDL edges, can lead to stress concentration points and membrane punctures when the MEA is compressed.

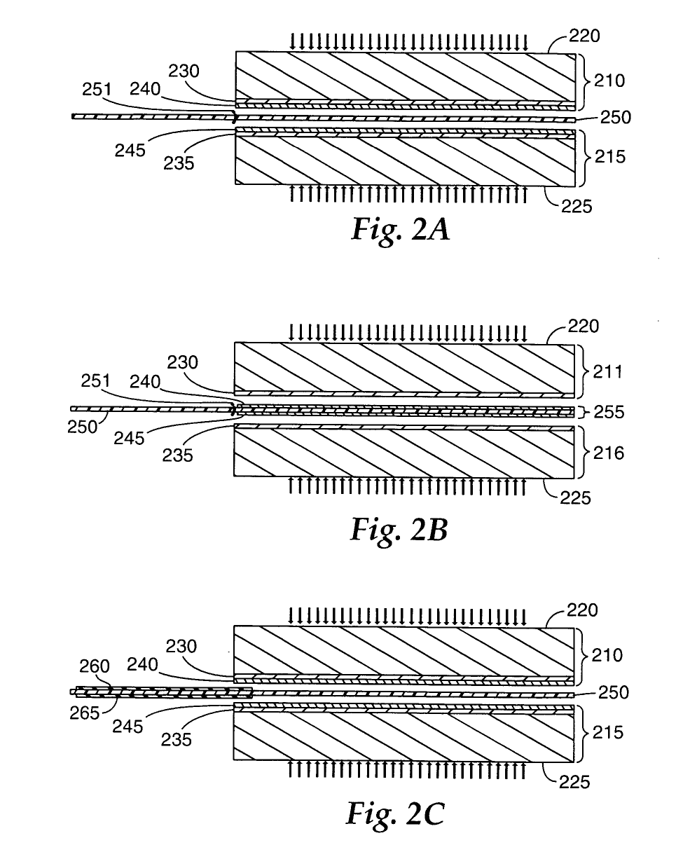

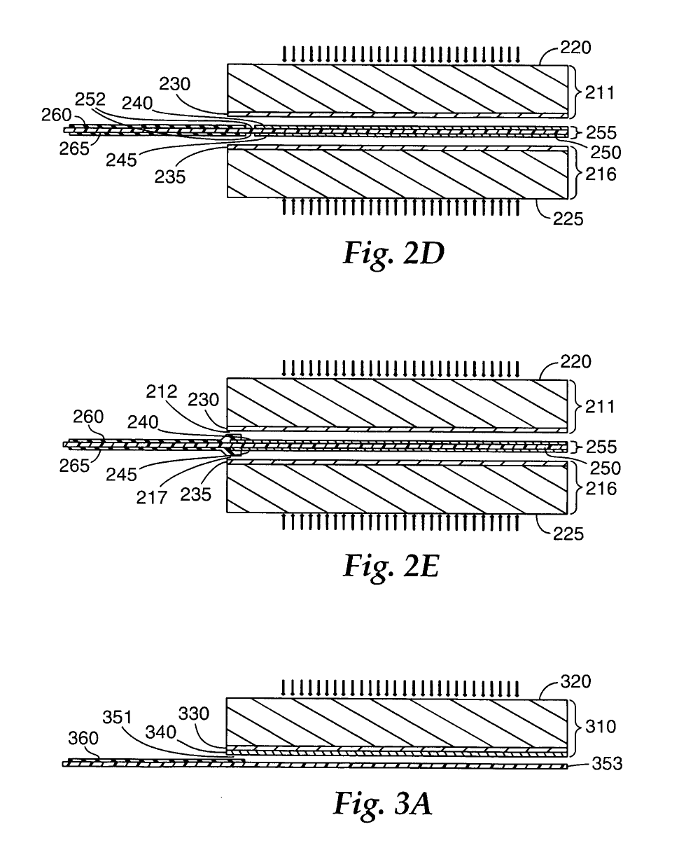

FIG. 2A illustrates a typical catalyst coated electrode backing (CCEB) based MEA structure. A MEA structure comprises a PEM 250 sandwiched between CCEB structures 210, 215. The CCEB structures comprise GDL layers 220, 225 having anode and cathode gas diffusion microlayers 230, 235 coated with anode and cathode catalyst layers 240, 245. The CCEBs 210, 215 are bonded at high pressure and temperature to the PEM 250 such that intimate contact between the membrane and catalyst layers is obtained. Adequate contact reduces impedance losses and enhances availability of catalyst. Furthermore, the CCEBs 210, 215 remain in place due to adhesion created between the catalyst layers and membrane. The GDLs 220, 225 on both sides of the consolidated MEA are further compressed between bipolar plates to maintain this intimate contact during the fuel cell operation.

While good contact between the catalyst layers 230, 235 and the membrane 250 reduces ohmic resistance losses, membrane tears at the periphery 251 of the GDL/membrane interface can occur due to the stresses of compression. When cells are operated for extended periods, edge tears and membrane damage may be observed where the CCEB 210, 215 presses against the membrane 250. Membrane damage of this sort leads to fuel and oxidant gas cross over.

FIG. 2B illustrates a cross sectional view of a catalyst coated membrane (CCM) 255 structure. In a CCM construction, heat and pressure are typically applied to effectively fuse catalyst layers 240, 245 to the membrane 250, forming a catalyst coated membrane 255. The GDL/gas diffusion microlayer structures 211, 216 are bonded to the CCM 255 with pressure and heat. Although the GDL/gas diffusion microlayer structures 211, 216 sometimes attach well, the degree of attachment is variable and it is not unusual for the GDL structures 211, 216 to delaminate from the CCM 255 during handling. To prevent this, typically the GDL structures 211, 216 are sized a little larger than the active area of the membrane, creating an overlap. The gas diffusion microlayers 230, 235 are thus directly in contact with the membrane 250 in the overlap region. This creates firmer attachment between the GDL structures 211, 216 and the membrane 250, but carbon agglomerates in the gas diffusion microlayers 230, 235 or exposed carbon fibers at the GDL edges may correspondingly create membrane damage at the periphery 251 of the GDL/membrane interface.

Some embodiments of the invention involve a subgasket formed over a peripheral portion of the PEM of an MEA assembly. FIG. 2C is a cross section of a CCEB based MEA that illustrates subgasket layers 260, 265 in accordance with embodiments of the invention. In this embodiment, the subgasket layers 260, 265 are disposed on a peripheral portion of the PEM 250 between the PEM 250 and the CCEBs 210, 215. The peripheral edges of the CCEBs 210, 215 overlap the subgasket layers 260, 265. For example, a peripheral edge of the CCEB 210, 215 may overlap the subgasket by about 0.05 mm to about 10 mm.

A subgasket layer 260, 265 may be deposited on one side or on both sides of the PEM 250. The subgasket layers 260, 265 and are cured in place after deposition.

The subgasket layers 260, 265 comprise a material that is depositable in liquid or flowable form so that the material can be dispensed or metered onto the PEM or other MEA structures. Screen printing, gravure coating, pattern coating, ink jet printing, or other appropriate deposition techniques may be used to deposit the subgasket material, for example. The subgasket material may comprise, for example, a liquid monomer/oligomer dispersion mixture. The dispersion mixture is capable of being placed into a flowable state so that the mixture can be dispensed or metered.

The subgasket material is formed of a material that is curable on the MEA structures in situ. “In-situ” curing means that the subgasket is cured in place against or on the surface in the position where the subgasket was applied. The subgasket material may be cured, for example, by irradiating, heating, and/or cooling the deposited subgasket material. In some embodiments, the subgasket may be formed of a thermoplastic material, for example. The subgasket material may be cured by exposing to the deposited subgasket material to moisture or reactive gases, and/or by using other curing methodologies.

In various embodiments, curing the subgasket material may or may not involve a chemical change of the subgasket material. In one example, the subgasket material may be deposited in molten form. Curing the subgasket material may be accomplished, for example, when the material cools from the deposited liquid state to a solidified polymer at room temperature. In another example, the curing of the subgasket material comprises a chemical change of the deposited material, such as polymer cross-linking by ultraviolet (UV) curing processes.

FIG. 2D illustrates a cross section of a CCM-based MEA where the GDL structures 211, 216 overlap the CCM 255 in accordance with embodiments of the invention. The peripheral edges of the GDL structures 211, 216 overlap the subgasket layers 260, 265. For example, a peripheral edge of the GDL structures 211, 216 may overlap the subgasket by about 0.05 mm to about 10 mm.

In this example, the subgasket layer is formed on a peripheral portion of the PEM 250 so that there are gaps 252 between the catalyst 240, 245 and the subgaskets 260, 265. In this configuration the active areas of the catalysts 240, 245 are not reduced by overlapping subgaskets.

FIG. 2E illustrates a CCM-based MEA cross-section in accordance with embodiments of the invention. In this embodiment, the GDL structures 211, 216 overlap the subgaskets 260, 265 on the CCM 255 such that the perimeters 212, 217 of the GDL structures 211, 216 do not directly contact the CCM 255 or the bare membrane 250. In this configuration, the protective subgaskets 260, 265 overlap a peripheral portion of the active area of the CCM 255 slightly to prevent reactant gases from directly impinging on the membrane 250.

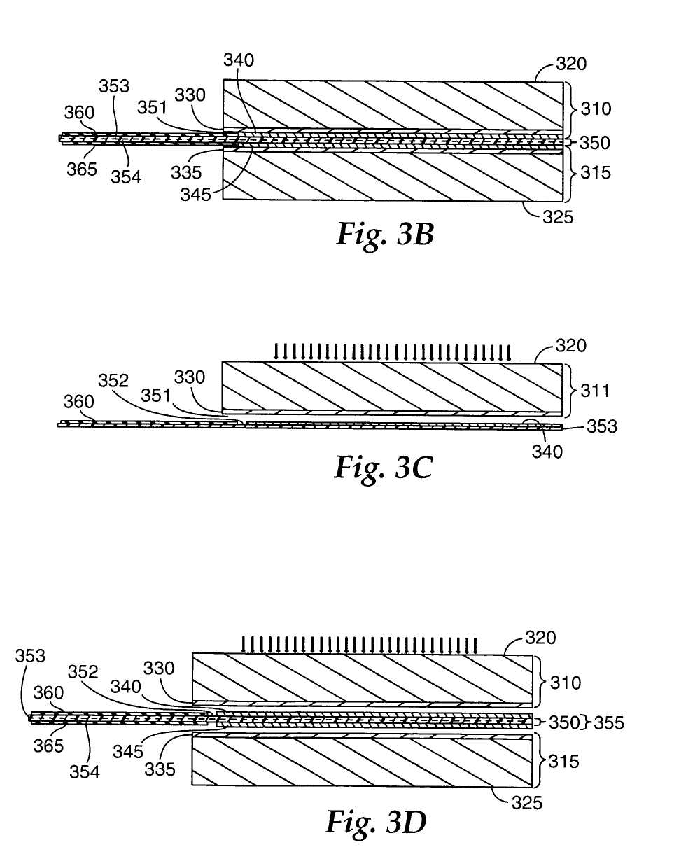

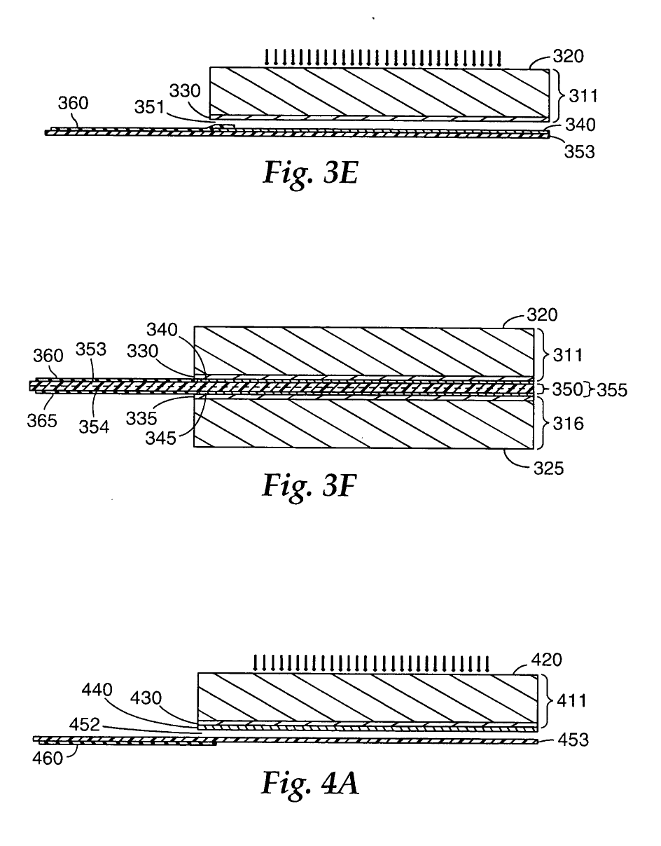

FIG. 3A shows a cross-sectional view of a CCEB-based MEA sub-assembly (or ½-MEA) in accordance with embodiments of the invention. In this embodiment, the CCEB 310, including gas diffusion layer 320, gas diffusion microlayer 330, and catalyst layer 340, is bonded to the membrane 353 in such a way that the CCEB 310 overlaps the protective subgasket 360 of this invention. In this configuration, the GDL perimeter 351 does not directly contact the membrane 353.

FIG. 3B illustrates a cross sectional detail of two ½-MEA sub-assemblies, as described in connection with FIG. 3A, bonded together with the membrane surfaces 353, 354 directly opposed, resulting in an MEA with a “fused” bilayer membrane 350. Note that FIG. 3B shows a dashed line where the membrane layers 353, 354 fuse. Each CCEB 310, 315 respectively includes GDL 320, 325, microlayer 330, 335, and catalyst layer 340, 345. Because the various layers are thin and conformable and because the CCEBs 310, 315 are compressible in nature, the layered structure that results is essentially flat. If the protective subgaskets 360, 365 are applied too thickly, however, a hard band may appear where the CCEB 310, 315 overlaps the protective subgasket 360, 365, when the MEA is compressed between bipolar plates.

FIG. 3C shows cross sectional view of a CCM-based sub-assembly (½-MEA structure) in accordance with embodiments of the invention. The GDL 311 overlaps the applied protective subgasket 360 of this invention such that the GDL perimeter 351 does not directly contact the membrane. Similarly to the MEA structure depicted in FIG. 2D, the subgasket 360 is formed so that there is a gap 352 between the subgasket 360 and the catalyst layer 340.

FIG. 3D illustrates a cross sectional view of two CCM sub-assemblies of the type described in connection with FIG. 3C bonded together to form an MEA structure. In accordance with this embodiment, the membrane surfaces 353, 354 of the ½-MEA structures are directly opposed to result in a CCM 355 with a “fused” bilayer membrane 350 as shown. Note that FIG. 3D shows a dashed line where the membrane layers 353, 354 fuse. As depicted in FIG. 3C, gaps 352 between the protective subgaskets 360, 365 and the catalyst 340, 345 coated area of the fused bilayer PEM 350 prevent reduction in the catalyst active area dimensions. The GDLs 311, 316 are shown in the positions where they would be bonded and consolidated to the protected bilayer CCM 355.

Another embodiment of the invention is illustrated in FIG. 3E. FIG. 3E depicts a CCM-based ½-MEA sub-assembly. The protective subgasket layer 360 overlaps the catalyst layer 340 that covers membrane 353. Due to this overlap, the GDL 311 does not directly contact the catalyst 340 or the membrane 353 at the perimeter of the GDL-CCM interface 351. In this configuration, the subgasket 360 is disposed between the PEM 350 and the GDL 311 with a portion of the subgasket disposed between the GDL 311 and the catalyst layer 340.

FIG. 3F illustrates the fusion of two CCM subassemblies of the type illustrated in FIG. 3E. The ½-MEA subassemblies are bonded together to make a CCM 355 having a fused bilayer membrane 350. Protective subgaskets are disposed over the catalyst layers 340, 345 of the CCM 355 as shown. Similar to the embodiment illustrated in FIG. 2E, the protective subgaskets 360, 365 overlap the active area slightly to prevent reactant gases from directly impinging on the membrane. The GDL layers 311, 316 are disposed over of the protective subgaskets 360, 365 in the positions shown.

Note that FIG. 3F shows a dashed line where the membrane layers 353, 354 fuse. Because the various layers of the MEA structure are thin and conformable and because the GDLs 311, 316 are compressible in nature, the layered structure that results is essentially flat. If the protective subgasket layer 360, 365 applied too thickly, a hard band will be appear where the GDL 311, 316 overlaps the protective subgasket 360, 365, when the MEA is compressed between bipolar plates.

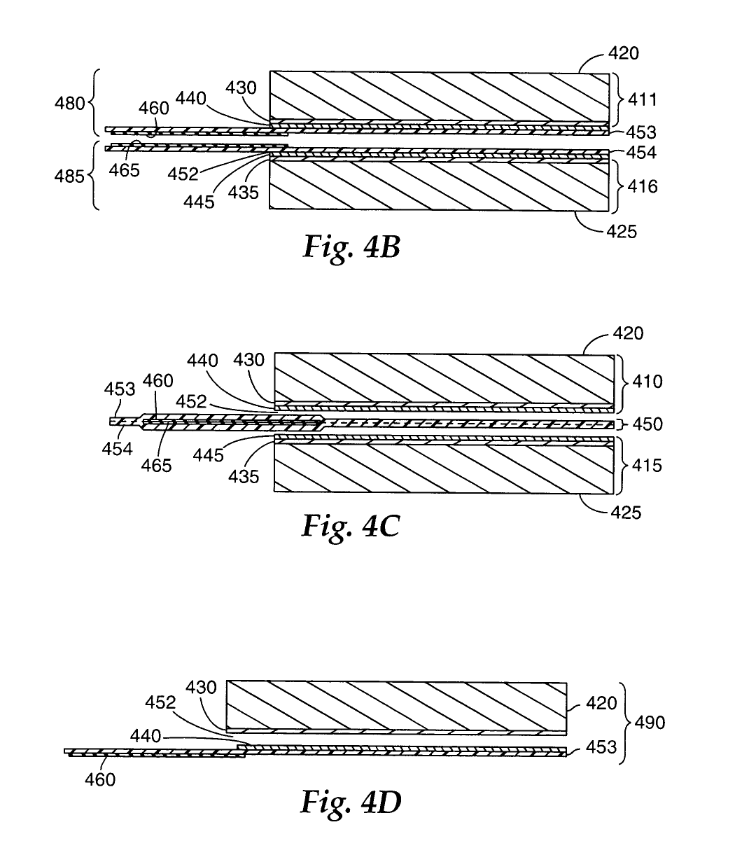

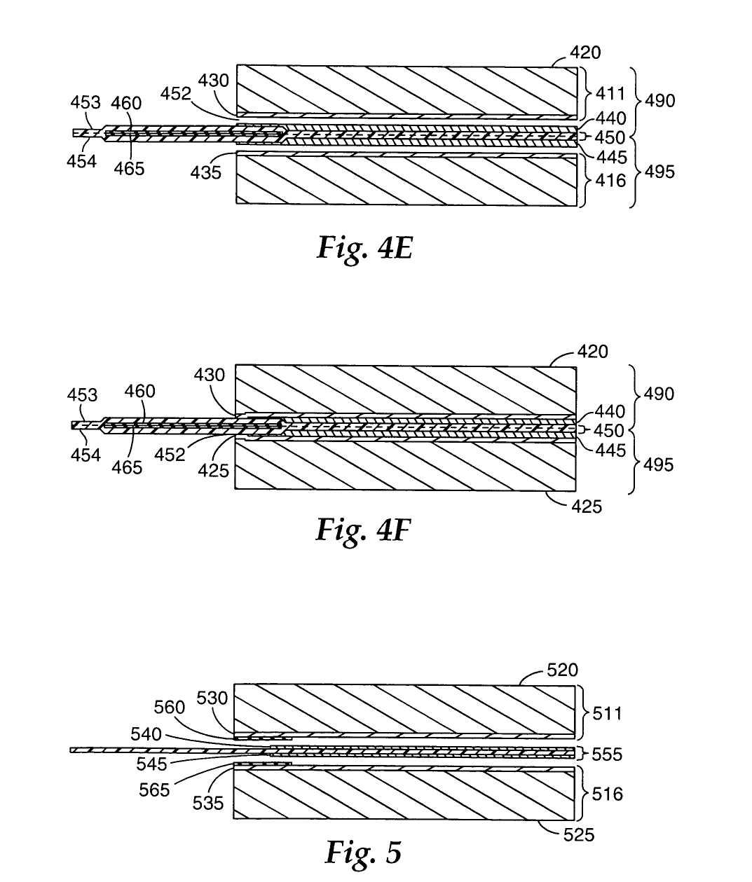

Various embodiments of the invention, illustrated in FIGS. 4A-4F involve protective subgasket layers disposed between fused layers of a bilayer membrane. FIG. 4A illustrates a ½-MEA subassembly having a subgasket layer 460 disposed on the backside of membrane 453. The subgasket layer 460 so positioned so that it reinforces the perimeter region 452 where the GDL structure 411 (GDL 420 and microlayer 430) is bonded to the membrane 453.

FIG. 4B illustrates two ½-MEA subassemblies 480, 485 prior to fusing to form a full MEA. Each of the ½ MEAs 480, 485 respectively includes a GDL structure 411, 416, a catalyst layer 440, 445, and a fusible membrane 453, 454. The ½-MEAs 480, 485 have subgasket layers 460, 465 disposed on the backside of fusible membranes 453, 454. After fusing, the subgasket layers 460, 465 form a reinforcing layer within the fused membrane that protects the fused membrane in the perimeter region 452.

FIG. 4C illustrates a cross section of a CCEB-based MEA assembly in accordance with embodiments of the invention. The MEA subassembly has protective subgasket layer(s) 460, 465 applied to the backside of membranes 453, 454. Membranes 453, 454 are fused to form a fused bi-layer membrane 450. Note that FIG. 4C shows a dashed line where the membrane layers 453, 454 fuse. FIG. 4C illustrates CCEBs 410, 415 positioned above the fused membrane 450, the fused membrane 450 including internal subgasket layers 460, 465. The two edge protected membrane sub-assemblies 453, 454 can be laminated with the membrane surfaces directly opposed to result in an MEA with a bilayer membrane 450 with an internal reinforced edge. The CCEBs 410, 415 are shown in position to be bonded to the fused bilayer membrane 450 after the bilayer membrane 450 is created in a previous step.

The general concept of a fused bilayer membrane with an internal reinforcing layer can be extended to create additional permutations, such as a CCM with a bilayer membrane having a reinforced edge. In such a construction, the protective subgasket layer(s) are sealed inside the bilayer membrane and are thus not exposed directly to attack by fuel, oxidant, water or catalyst.

FIG. 4D illustrates a cross sectional view of a CCM-based MEA sub-assembly (½-MEA) 490 in accordance with embodiments of the invention. In this example, protective subgasket layer(s) 460 of this invention are applied to the backside of the membrane 453, reinforcing the perimeter region 452 where the GDL later engages with the membrane 453.

FIG. 4E illustrates CCM sub-assemblies 490, 495 of this construction prior to laminating the sub-assemblies 490, 495 together (as in previous figures) with the membrane 453, 454 surfaces directly opposed to form a bilayer membrane 450 with a reinforced edge. The GDL 411 shown in position could be bonded to the CCM sub-assemblies 490, 495 either before or after the bilayer membrane 450 is formed.

FIG. 4F illustrates cross section of a full MEA having a bilayer membrane 450 with a internal subgasket layers 460, 465 forming a reinforced edge. Note that FIG. 4F shows a dashed line where the membrane layers 453, 454 fuse. As mentioned previously, due to the thin layers and their conformable nature, the final consolidated MEA is essentially flat.

FIG. 5 illustrates a cross section of a CCM-based MEA structure prior to bonding in accordance with embodiments of the invention. The CCM-based MEA includes catalyst layers 540, 545 fused to the membrane 550 forming a catalyst coated membrane 555. The GDL structures 511, 516 include gas diffusion layers 520, 525 and gas diffusion microlayers 530, 535. The GDL structures 511, 516 are bonded to the CCM 555 with pressure and heat. The MEA structure depicted in FIG. 5 includes protective subgasket layers 560, 565 of this invention disposed on peripheral portions of the GDLs 511, 516 to produce an MEA with a ruggedized GDL edge.

The present invention comprises deposition of a subgasket protective layer between the GDL perimeter and the membrane. The formation of the subgasket protective layer reduces membrane damage along the perimeter interface of the MEA. The deposited subgasket layer coats and protects the membrane from moisture. The subgasket layer makes the membrane more stable, reducing wrinkling of the membrane in the MEA perimeter. Wrinkles of membrane, particularly when they occur at the GDL edges, can lead to stress concentration points and membrane punctures when the MEA is compressed. The protective subgasket layer may comprise an ionically or electrically nonconductive material.

The material used to form the protective subgasket layer of this invention may be deposited onto the membrane, GDL, or other MEA components by a variety of methods. Deposition methods may include screen printing, coating, e.g., gravure coating or pattern coating, spraying, such as by ink-jet printing, or by other deposition methods. The subgasket material may be deposited, for example, into a pattern of congruent shape but slightly smaller or slightly larger area than the active area pattern of the MEA. The pattern is may be sized such that the perimeter edges of the GDL overlap the protective layer. Typically the amount of overlap is about 0.05 mm to about 10 mm.

If a CCEB (catalyst coated electrode backing) approach is being used, the protective subgasket layer is sized such that the CCEB perimeter overlaps the protective coating. If a CCM (catalyst coated membrane) approach is being used, the protective subgasket layer can be applied such that it is larger or smaller than the active area. In either case, the protective layer is sized such that the GDL will overlap it.

The protective subgasket layer can be applied either before the CCM is made (with the catalyst later being applied to the uncoated window) or the protective coating can be applied after the CCM has been prepared. When the protective coating is applied after the CCM is made, the coating can either overlap the catalyst active area or can be sized to leave a narrow margin of uncoated membrane around the active area.

After deposition onto the membrane, the protective subgasket layer may be cured by drying, heating, cooling, exposure to radiation, electric fields, moisture, gases, or by other curing methods. In various implementations, the curing process may involve an irreversible change as the material is cured from a flowable form to a solid form. Curing may involve chemically altering the subgasket material such as by chemical cross linking of polymers in the material.

The subgasket material may be curable through exposure to radiation of various wavelengths, including light in the UV or visible spectra, e-beam radiation, and/or other types of radiation.

The subgasket material may be curable by exposure to moisture, such as moisture from the air or from the components of the MEA. A material suitable for moisture curing includes, for example, 3M JET MELT. Moisture curable materials such as polyurethane hot melt adhesives may be produced from a combination of polyester and/or polyether polyols. These materials form pre-polymers with terminated isocyanate groups when they react with an excess of di-isocyanate. The pre-polymers can be deposited as a subgasket layer by gravure coating, screen printing, or via slot nozzles.

The subgasket material may be curable through exposure to various gases including reactive gases such as plasmas or through exposure to an electric field.

Certain categories of dispensable subgasket materials may be curable by cooling to induce phase changes such that the subgasket material remains solid at fuel cell operating temperature. The phase change may be reversible or irreversible, however an irreversible phase change is preferred.

The protective layer of this invention has been found to physically protect membrane from damage caused by the rough fibrous edges of the GDL, damage caused by particulates or large agglomerates in the GDL microlayer coating, edge tearing that often occurs at the membrane/catalyst or membrane/GDL interface, dimensional changes that result from humid air exposure or dehydrating conditions, and/or chemical decay that occurs between incoming gases and membrane during fuel cell operation.

The mechanical properties of the composite structure (membrane plus protective subgasket layers) are enhanced over the mechanical properties of a bare membrane. Elastic modulus, puncture resistance and trouser tear resistance of the membrane are improved. The durability of the membrane in fuel cell operation is increased due to the improved mechanical properties provided by the protective subgasket of the present invention.

Further, the use of the subgasket described herein enhances dimensional stability of the membrane in humid air or at elevated temperatures. Adhesion between the membrane and the protective layer is increase, such that the coatings remain adhered even in the presence of boiling water. The interface between the membrane and the protective coatings is sufficient to prevent gas leakage.

The subgasket of this invention is suitable for MEA's made in a variety of configurations. In one configuration the MEA consists of a GDL structure and a catalyst coated PEM membrane (CCM). In another configuration the MEA consists of an unmodified PEM membrane combined with a catalyst coated GDL structure. A catalyst coated GDL structure may also be called a catalyst coated electrode backing (CCEB).

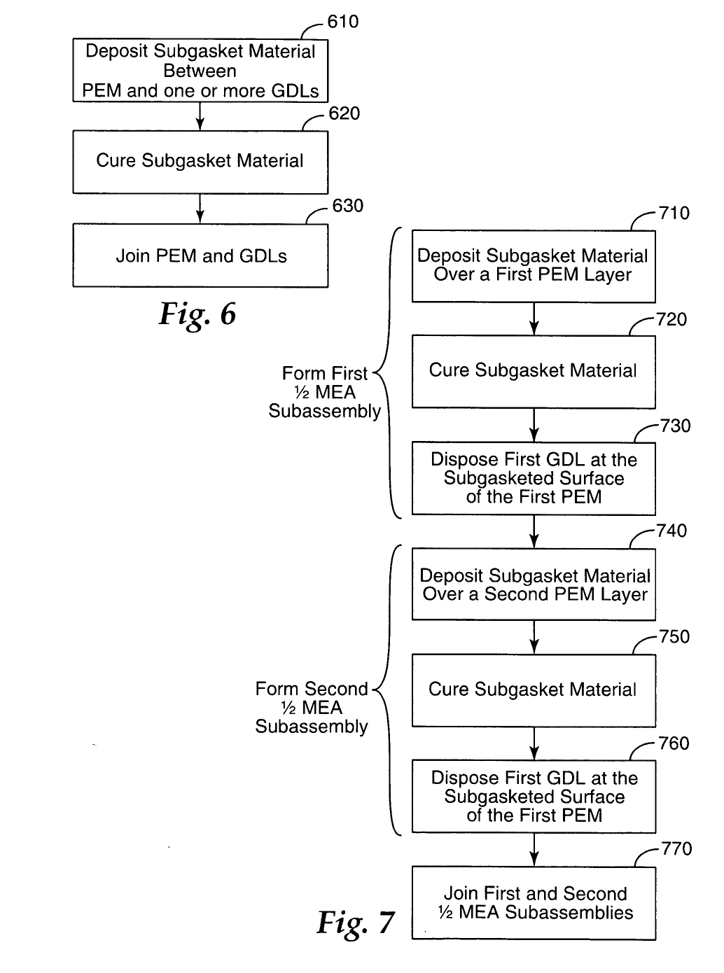

The flowcharts of FIGS. 6 and 7 illustrate processes involved in making MEA assemblies and subassemblies in accordance with embodiments of the invention. As illustrated by the flowchart of FIG. 6, a method for making an MEA subassembly involves depositing 610 a dispersible subgasket material over a GDL structure. The dispersible subgasket material may be deposited, for example, by screen printing, by various coating techniques, including gravure coating and pattern coating, or by a spraying methodology, such as ink-jet printing. In this embodiment the GDL structure may comprise a catalyst coated electrode backing (CCEB).

FIG. 6 illustrates a method of forming a MEA assembly. After deposition 610, the subgasket material is cured 620 in situ to form a subgasket on the GDL structure. The subgasketed GDL is disposed 630 over one surface of a PEM structure. A full MEA may be formed by coupling a second subgasketed GDL structure to the first subgasketed GDL structure. The second subgasketed GDL structure is coupled to the free surface of the PEM. In some implementations, the PEM may be a catalyst coated membrane (CCM).

FIG. 7 illustrates a method of forming a MEA assembly. A dispersible subgasket material is deposited 710 over a first PEM layer and cured 720 in situ. A first GDL is disposed 730 at the surface of the first PEM forming a first ½ MEA subassembly. Subgasket material is deposited 740 over a second PEM layer and cured 750 in situ. A second GDL is disposed 760 at the surface of the first PEM forming a second ½ MEA subassembly. The first and the second ½ MEA subassemblies are joined to form a full MEA.

Subgasket layers deposited and cured in situ in accordance with the embodiments described above provide a number of advantages over previously used filmic subgaskets. Subgasket layers serve to physically protect the membrane from damage. Damage to the membrane may be caused by rough, fibrous edges of the GDL and/or particulates or large agglomerates in the GDL microlayer coating. Previously, edge protection methods involved lamination of thin rigid filmic substrates to the membrane. Previous edge protection methods used thin materials to reduce the hard band where the GDL overlaps with the edge protection. Handling and cutting of these thin materials without wrinkling is difficult due to their frail nature and due to static charges. In addition, a significant amount of material is wasted due to the discarded window portion. The use of methods in accordance with embodiments described herein, the protective material is selectively applied where needed, resulting in less waste.

Furthermore, the use of methods in accordance with embodiments described herein reduce the need to have complex thin film cutting and winding equipment, as required by the previous methods.

Deposition and in situ curing of subgaskets, as described in embodiments of the present invention, reduces the incidence of membrane damage caused by the edges of filmic subgaskets. Cutting of the filmic materials used in known edge protection methods commonly leaves edge burrs or splintery defects on the cut edge. The sharp burrs or edges of the filmic subgaskets can cause damage to the membrane. The damage may be exacerbated in cases where the membrane expands or contracts due to humidity or temperature changes, or in circumstances where cell compression is high.

Subgaskets formed in accordance with embodiments of the invention provide enhanced adhesion of the subgasket to the membrane over prior methods. A typical rigid filmic subgasket used in MEA fabrication by prior methods is made from 1.2 mil Mylar, commonly called OL-12. The typical rigid filmic subgasket of prior methods is typically either placed against the membrane or laminated to the membrane. OL-12 clings only through cohesive forces and thus a gas leak path is possible.

When OL-12 is used, typically it is placed on only one side of the membrane as a stack or cell is assembled. Because the layers are thin and clingy and difficult to handle, the layers are frequently used only on one side of the membrane. This single-sided approach can result in attack or degradation on the other side, which is uncovered. When a one-sided subgasket method is used, the MEA perimeter edge is also prone to severe curling. Subgaskets deposited and cured using the approaches of this invention allow protective layers to be easily applied to both sides of the membrane.

The monomeric and oligomeric dispersion components used in subgasket formation according to embodiments of the invention partially penetrate and swell the ionomer membrane before they are cured. The penetration and swelling of the ionomer membrane creates a very strong bond between the protective layer and the membrane. Such a bond is capable of surviving extended exposure to liquid water and even boiling water. The adhesion between the protective subgasket layer and membrane is much stronger than what is achievable using the filmic subgaskets previously used.

The subgaskets deposited and cured according to embodiments of the invention provide edge protection with reduced thickness. With a filmic subgasket, it is difficult to obtain films thinner than 1 mil, and more typically a film of 1.2 mils thickness is used. Using the printing and zone-coating approach of this invention, uniform protective layers as thin as 0.2 mils can easily be deposited.

The subgaskets of the present invention provide reduced moisture absorbency. Fuel cell membranes are generally dimensionally unstable and susceptible to both humid air and liquid water. Membranes expand and contract as humidity levels change. Using the subgaskets of this invention, the moisture absorbency of the protected membrane is significantly less than that of an unprotected membrane.

As described in Example 1, below, when bone dry membrane was hydrated at saturated conditions at room temperature for 10 minutes, it gained 51% of its original weight. Membrane that was protected by the subgasket material deposited and cured as described herein gained just 18% under the same conditions. From a dimensional stability standpoint, a section of bare membrane increased in length by 21% after identical humidification, compared to an 11% increase for protected membrane.

When a droplets of water were placed on bare membrane, the membrane in contact with the droplet wrinkled noticeably. There were no wrinkles in the vicinity when a droplet of the water was placed on protected membrane of Example 1.

A subgasketed membrane in accordance with embodiments of the invention provides improved mechanical properties compared to a bare membrane. The elastic modulus of a membrane protected by a subgasket deposited and cured according to embodiments described herein is higher than that of an bare membrane. Samples of bare and protected membranes were cut to 0.5″×8″ sizes and were subjected to tensile loading. Bare membrane stretched to 40% of original length at a load of 845 kg f/cm2, compared to a load of 1665 kg f/cm2 required to stretch protected membrane of Example 1 by the same amount. This indicates that protected membrane was about twice as tough as bare membrane.

In tensile strength measurements on 0.5″×8″ samples, bare membrane broke at a stress of 856 kgf/cm2 compared to the protected membrane of Example 1 which broke at 3330 kgf/cm2. This indicates that tensile strength was about three fold higher. Puncture resistance was higher for the protected membrane at 65 psi as compared to the bare membrane at 60 psi.

Trouser tear strength, as measured by an Instron method, is a gauge of how resistant a material is to crack propagation once a slice or point defect has been initiated. This value is typically extremely low for homogenous fuel cell membranes. The membrane of Example 1, protected by a subgasket of the present invention, had trouser tear strength of 5.5 grams compared to 3.1 grams for bare membrane. This is a substantial enhancement of trouser tear strength over a bare membrane. Thermal annealing or increasing the thickness of a bare membrane, e.g., 25% increase in thickness, typically improves the trouser tear strength. However, use of the subgasket material of the present invention provides trouser tear strength improvements beyond those gained by thermal annealing or increased thickness. For example, in a comparison of 160 C and 200 C annealing of 3M ionomer membrane, trouser tear strength increased downweb from 2.4 grams to 3.3 grams, and crossweb from 2.1 grams to 2.8 grams crossweb. Similarly small differences are seen between 1-mil and 1.5 mil cast Nafion®.

Subgaskets formed by deposition and in situ curing in accordance with embodiments of the invention provide reduced sensitivity to thermal shrinkage. When a cast membrane is removed from the liner, it is susceptible to dimensional changes caused by thermal exposure, even if no tension is applied. A bare membrane exposed at 150 F and 100% RH shrank about 2% or 20,000 ppm. A membrane protected by subgasket material formed as described herein (Example 1) exposed under identical conditions shrank only about 1.5% or 15,000 ppm.

The use of subgaskets of the present invention improves the adherence of the GDL to the membrane after MEA is assembled. Typically, GDLs do not adhere well to a previously formed CCM, even when substantial heat and pressure are applied. In some scenarios, the GDLs remain attached only if the MEA is carefully handled. The membrane protection layers of this invention are conformable and compliant even after curing. It is noteworthy that GDLs bond readily to the subgasket materials described herein under moderate heat and pressure.

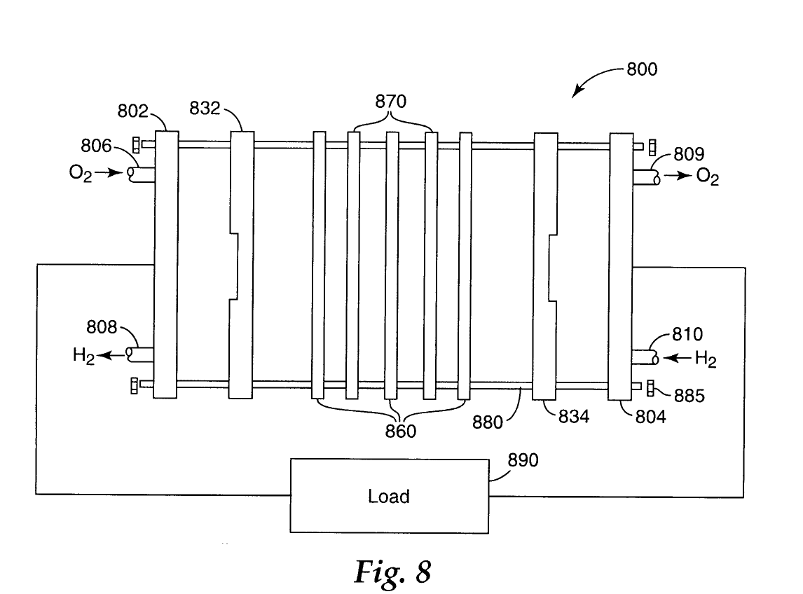

FIG. 8 depicts a simplified fuel cell system that facilitates an understanding of the operation of the fuel cell as a power source. The fuel cell system 800 shown in FIG. 8 includes a first and second end plate assemblies disposed at each end of a fuel cell stack. The fuel cell stack includes flow field plates 832, 834 configured as monopolar flow field plates disposed adjacent the end plates 802, 804. A number of MEAs 860 and bipolar flow field plates 870 are situated between the first and second end plates 802, 804. These MEA components preferably utilize subgaskets formed as described above.

Connecting rods 880 through the end plates 802, 804 may be used to preferentially compress the fuel cell stack as the connecting rod nuts 885 are tightened. Current collected from the fuel cell stack is used to power a load 890.

As illustrated in FIG. 8, the fuel cell system 800 includes a first end plate 802 having a first fuel inlet port 806, which can accept oxygen, for example, and a second fuel outlet port 808, which can discharge hydrogen, for example. A second end plate 804 includes a first fuel outlet port 809, which can discharge oxygen, for example, and a second fuel inlet port 810, which can accept hydrogen, for example. The fuels pass through the stack in a specified manner via the various ports 806, 808, 809, 810 provided in the end plates 802, 804 and manifold ports provided on each of the MEAs 860 and flow field plates 870 (e.g., UCAs) of the stack.

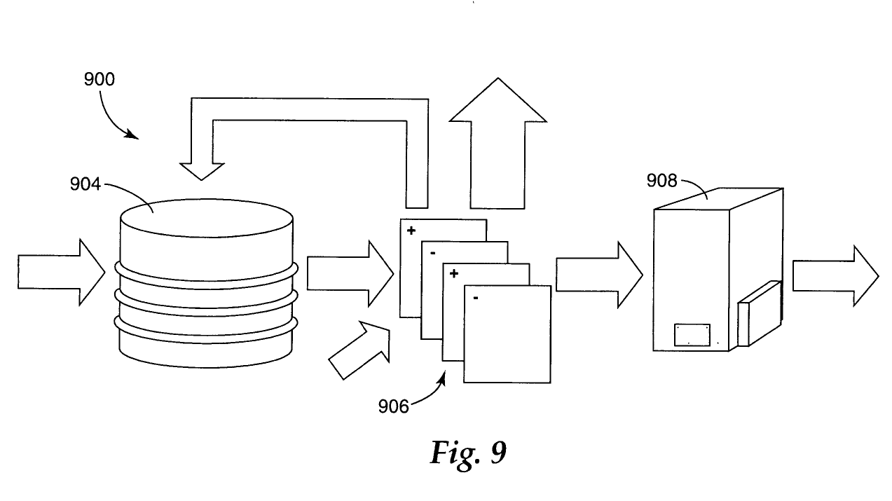

FIGS. 9-12 illustrate various fuel cell systems that may incorporate the fuel cell assemblies described herein and use a fuel cell stack for power generation. The fuel cell system 900 shown in FIG. 9 depicts one of many possible systems in which a fuel cell assembly as illustrated by the embodiments herein may be utilized.

The fuel cell system 900 includes a fuel processor 904, a power section 906, and a power conditioner 908. The fuel processor 904, which includes a fuel reformer, receives a source fuel, such as natural gas, and processes the source fuel to produce a hydrogen rich fuel. The hydrogen rich fuel is supplied to the power section 906. Within the power section 906, the hydrogen rich fuel is introduced into the stack of UCAs of the fuel cell stack(s) contained in the power section 906. A supply of air is also provided to the power section 906, which provides a source of oxygen for the stack(s) of fuel cells.

The fuel cell stack(s) of the power section 906 produce DC power, useable heat, and clean water. In a regenerative system, some or all of the byproduct heat can be used to produce steam which, in turn, can be used by the fuel processor 904 to perform its various processing functions. The DC power produced by the power section 906 is transmitted to the power conditioner 908, which converts DC power to AC power for subsequent use. It is understood that AC power conversion need not be included in a system that provides DC output power.

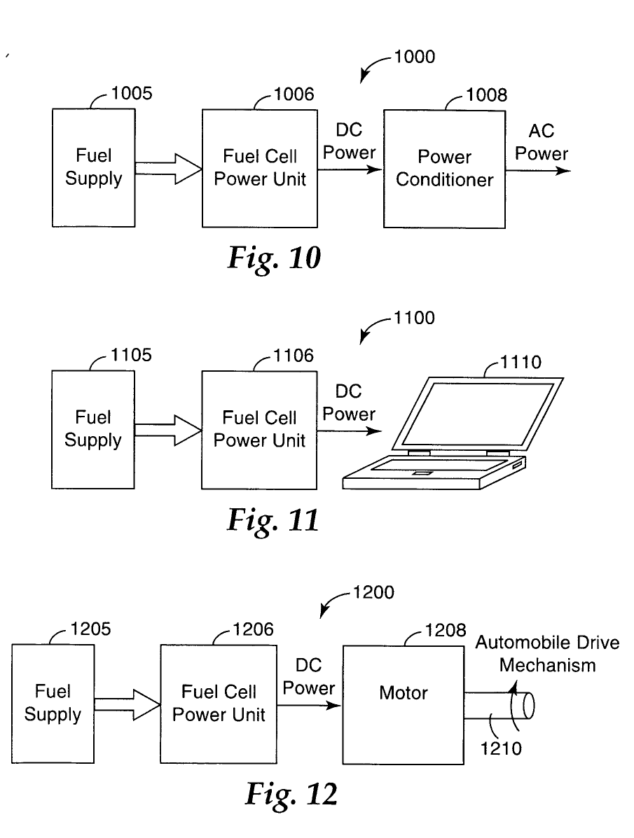

FIG. 10 illustrates a fuel cell power supply 1000 including a fuel supply unit 1005, a fuel cell power section 1006, and a power conditioner 1008. The fuel supply unit 1005 includes a reservoir containing hydrogen fuel that is supplied to the fuel cell power section 1006. Within the power section 1006, the hydrogen fuel is introduced along with air or oxygen into the UCAs of the fuel cell stack(s) contained in the power section 1006.

The power section 1006 of the fuel cell power supply system 1000 produces DC power, useable heat, and clean water. The DC power produced by the power section 1006 may be transferred to the power conditioner 1008, for conversion to AC power, if desired. The fuel cell power supply system 1000 illustrated in FIG. 10 may be implemented as a stationary or portable AC or DC power generator, for example.

In the implementation illustrated in FIG. 11, a fuel cell system 1100 uses power generated by a fuel cell power supply to provide power to operate a computer. As described in connection with FIG. 10, fuel cell power supply system includes a fuel supply unit 1105 and a fuel cell power section 1106. The fuel supply unit 1105 provides hydrogen fuel to the fuel cell power section 1106. The fuel cell stack(s) of the power section 1106 produce power that is used to operate a computer 1110, such as a desk top or laptop computer.

In another implementation, illustrated in FIG. 12, a fuel cell system 1200 uses power from fuel cell power supply to operate an automobile. In this configuration, a fuel supply unit 1205 supplies hydrogen fuel to a fuel cell power section 1206. The fuel cell stack(s) of the power section 1206 produce power used to operate a motor 1208 coupled to a drive mechanism of the automobile 1210.

### EXPERIMENTAL

The examples provided below describe various processes involved in making an MEA structure in accordance with embodiments of the invention.

### General Methodology

The dispersive solutions that make up the protective subgasket layer are mixed thoroughly to form a uniform liquid mixture (hereafter referred as “dispersion.”) Application of the dispersion to the PEM or GDL structure is preferably performed by screen printing. The PEM was removed from the liner and laid out flat on a screen printing table, held in place at the edges by tape. Using a screen with a desired pattern, a thin layer of the dispersion was applied to the PEM. The thickness of the deposited subgasket layer was controlled by the screen mesh size. For example, the subgasket may have a thickness of about 5 μm to about 100 μm. The pattern in the screen was designed so that the uncoated region of the membrane was slightly smaller than the GDL or CCEB size being used. A 270 mesh screen was used to deposit a ˜1 mil thick layer of protective coating.

The “wet” coating of the first subgasket layer was cured using a UV lamp of suitable wavelength and intensity. The UV equipment used was Model # DRS-120, Fusion Systems, Inc., Gaithesburg, Mass. A D or H-type bulb may be used, curing the subgasket layer at 4 ft/min. The bulb type differed according to the chemistry of the applied dispersions.

The partially coated membrane was flipped and laid out flat on a screen printing table using tape, then the second side of the membrane was coated. The subgasketed membrane was positioned on the table such the uncoated windows were aligned for each layer.

GDL/Catalyst attachment involved cutting pieces of CCEB or GDL to size with an appropriate die. The CCEB was sized slightly larger than the unprotected windows on the membrane, so that there was an overlap of about 100 mils around the edge of the GDL. CCEB pieces were placed on each side of the coated membrane with PTFE shims placed around the GDLs.

A stacked layered assembly was formed comprising a subgasketed membrane, two GDLs (one on top and one on bottom) and two PTFE gaskets placed around the GDLs. The components may be placed such that the edges of the GDLs and gaskets are aligned.

The layered assembly may be bonded by applying one or both of pressure and heat to the MEA components for a predetermined period of time. For example, heat may be applied at a temperature near the softening point of the PEM. Bonding may be accomplished by application of heat and pressure of about 132° C. (270° F.) and about 0.89 MPa (0.5 tons/50 cm²) to about 5.3 MPa (3.0 tons/50 cm²), preferably 2.7 MPa (1.5 tons per 50 cm²), for about 10 minutes to consolidate the layers and make a gasketed MEA. A pair of 5 mil PTFE shims on each side of the membrane may be employed during bonding to prevent overcompression.

### EXAMPLE 1

A UV curable dispersion mixture was prepared comprising 10 parts poly butadiene dimethacrylate oligomer (available under the trade designation “CN301” from Sartomer, Exton, Pa.) and 3 parts 1,6-hexanediol diacrylate (available under the trade designation “SR238” from Sartomer, Exton, Pa. 19341). Around 5% by weight of an α-hydroxy-acetophenone type photoinitiator (available under the trade designation SR1129 from Sartomer, Exton, Pa.) was used. This dispersion had a viscosity of around 1000 cps. Cast Nafion® 1100 membrane 1.1 mil in thickness was peeled off the carrier liner in the first step. To facilitate handling of the thin membrane, sections were taped onto a polyethyleneterepthalate (PET) carrier web that was threaded up on a screen printer. Dispersion was applied to said membrane using a patterned Gallus type screen. Screen mesh with 240 openings per inch was used to deposit a protective film of ˜1 mil thick on each side of the membrane. After each coating layer was applied, the dispersion was cured using a D type bulb. After printing and UV curing on one side, sections of membrane were flipped over and taped onto the PET carrier in inverted position. After the second pass of dispersion was applied and cured, the resulting membrane was coated on both sides with roughly 1 mil of tough resinous polymer.

### EXAMPLE 2

The dispersion mixture described in Example 1 above was printed onto membrane while the membrane was still attached to its PET carrier liner. Cast Nafion® 1100 membrane 1.1 mils thick on PET liner 3 mils thick, was threaded up from unwind to windup on a TELSTAR (Burnsville, Minn.) screen printing machine. The UV curable dispersion mixture was deposited on the PEM to a thickness of approximately 1 mil. The dispersion was cured with a D type bulb as in example 1. The membrane was then peeled off the liner. The resulting membrane had a frame of protective material on one side, applied around a window opening that was uncoated

### EXAMPLE 3

Samples of a UV protective varnish (Trimethylolpropane Triacrylate Ester) were obtained from Northern Coatings (Menominee, Mich.). Using the method of Example 2, the UV varnish was applied to a thickness of 2 mils onto the membrane. The dispersion was cured with a D type bulb as in example 1. The membrane was then peeled off the liner. The resulting membrane had a frame of protective material applied around a window opening that was uncoated. Although the protected membrane was significantly more resistant to stretching and deformation when tested by hand, the coating delaminated when the membrane was exposed to boiling water.

### EXAMPLE 4

An ink-jet printable sol-gel PSA dispersion was prepared of the following composition: 80 wt % of the monomer mixture: 80 parts 2-ethylhexylacrylate (2-EHA), 20 parts isobornyl acrylate (IBA), 0.10 parts 1,6 hexanediol diacrylate (HDDA) crosslinker and a photoinitiator (known under the trade designation “ESACURE KB-1” available from Sartomer, Exton, Pa.) and 20 wt % surface treated silica. This dispersion is described in US Pat. App. 2002/0128340, e.g. at Example 8 and at Table 4 and associated text, incorporated herein by reference. A draw-down coating method was used to apply this material in a 1-2 mil thickness to Nafion® 1100 as well as a copolymer of tetrafluoroethylene (TFE) and HOSO₂CF₂CF₂CF₂—CF₂OCF₂CF₂ as described in previously incorporated U.S. patent application Ser. No. 10/325,278. A 20-minute, UV cure was performed using a low pressure T5 germicidal UV tube to achieve PSA properties. This curing step is described in US Pat. App. 2002/0128340, e.g. at Example 9. The resultant film was tough and sticky. When stretched, the samples felt noticeably stronger compared to untreated membrane. A section of this material was boiled in distilled water for four hours, and the coating remained aggressively adhered to the membrane. The monomer may slightly penetrate into the membrane before curing, resulting in the enhanced adherence to the membrane. After the coating was cured, the anchorage was good due to this pre-swelling.

### EXAMPLE 5

A sample of 1.2 mils thick (160° C. annealed) 950 equivalent weight membrane, as described in previously incorporated U.S. patent application Ser. No. 10/325,278, was stretched taut on a glass plate. Using a stencil cut from 1-mil polyester, approximately 1 mil of vinyl plastisol resin (available under the trade designation “M3108 BLACK” from PolyOne Corporation, Avon Lake, Ohio) was applied in a frame pattern with an open area. The plastisol is a particulate filled formulation developed to have low creep at 80° C. After coating, the plastisol was heated to 170° C. for 10 minutes to gel and set the plastisol. No UV Cure was carried out. After cooling to room temperature, manual comparisons were made of the coated and uncoated membrane. The coated membrane was noticeably stronger and more resistant to stretching. The coating remained adhered after 2 hours in 80° C. DI water. After four hours of boiling in DI water, however, the plastisol layer came partially detached.

The plastisol may not have attached as well because there is no swelling of the membrane with a monomeric species. During operation in a fuel cell, however, the laminated structure is under pressure and is less likely to become detached. Vinyl plastisol resin was found to be stable when boiled in water for long periods of time without degradation. In general, vinyl plastisol polymers are known to be acid resistant and could be suitable candidates for protection.

### EXAMPLE 6

A UV curable dispersion was prepared comprising 10 parts of “ester backbone, aliphatic urethane acrylate oligomer” (available under the trade designation “CN964” from Sartomer, Exton, Pa. 19341) and 6 parts 1,6-hexanediol diacrylate (available under the trade designation “SR238” from Sartomer, Exton, Pa.). Around 5% by weight of an α-hydroxy-acetophenone type photoinitiator (available under the trade designation SR1129 from Sartomer, Exton, Pa. 19341) was added. This dispersion had a viscosity of around 2000 cps. Nafion® 1100 membrane 1.1 mil in thickness was peeled off the carrier liner in a first step. To facilitate handling of the thin membrane, sections were taped down onto a glass plate. Dispersion was applied to both sides of the 1.1 mil cast Nafion® 1100 using a screen printing mesh of 340 openings per inch such that a film of approximately one mil thickness was deposited on each side of the membrane. After each coating layer was applied, the dispersion was cured using a D type bulb. After printing and UV curing on one side, the membrane was flipped over and taped down in inverted position. After the second pass of dispersion was applied and cured, the resulting membrane was coated on both sides with roughly 1 mil of tough resinous polymer.

### EXAMPLE 7

A UV curable dispersion was prepared comprising 80 parts of a bisphenol A diglycidyl ether epoxy known under the trade designation “EPON 828” available from Resolution Performance Products, Houston, Tex. and 20 parts of a polyester polyol known under the trade designation “TONER 0201 POLYOL” available from Dow Chemical, Midland, Mich. 2% w/w of a photoinitiator known under the trade designation “CPI 6976” available from Dow Chemical, Midland, Mich. was added. This dispersion had a viscosity of around 4000 cps. Nafion® 1100 membrane 1.1 mil in thickness was peeled off the carrier liner in a first step. To facilitate handling of the thin membrane, sections were taped down onto a glass plate. Dispersion was applied to both sides of the 1.1 mil cast Nafion® 1100 using a screen printing mesh of 270 openings per inch such that a film of approximately one mil thickness was deposited on each side of the membrane. After each coating layer was applied, the dispersion was cured using a D type bulb. After printing and UV curing on one side, the membrane was flipped over and taped down in inverted position. After the second pass of dispersion was applied and cured, the resulting membrane was coated on both sides with roughly 1 mil of tough resinous polymer.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A structure for a membrane electrode assembly (MEA), comprising:
a membrane electrode subassembly having components, comprising:
a polymer electrolyte membrane;
a gas diffusion layer; and
a catalyst layer between the polymer electrolyte membrane and the gas diffusion layer; and
a subgasket, disposed over one or more components of the membrane electrode subassembly, a peripheral edge of the gas diffusion layer overlapping the subgasket, the subgasket comprising a layer of material that is depositable and curable in situ.

2. The MEA structure of claim 1, wherein the subgasket is disposed over a peripheral portion of the polymer electrolyte membrane.

3. The MEA structure of claim 1, wherein a portion of the subgasket is disposed between the catalyst layer and the polymer electrolyte membrane.

4. The MEA structure of claim 1, wherein a portion of the subgasket is disposed between the catalyst layer and the gas diffusion layer.

5. The MEA structure of claim 1, wherein the gas diffusion layer and the catalyst layer form a catalyst coated electrode backing and an edge of the catalyst coated electrode backing overlaps the subgasket.

6. The MEA structure of claim 1, wherein the polymer electrolyte membrane and the catalyst layer form a catalyst coated membrane and the subgasket is disposed over a peripheral portion of the catalyst coated membrane.

7. The MEA structure of claim 1, wherein the peripheral edge of the gas diffusion layer overlaps the subgasket by about 0.05 mm to about 10 mm.

8. The MEA structure of claim 1, wherein the subgasket material is curable in situ by radiation.

9. The MEA structure of claim 8, wherein the radiation comprises ultraviolet radiation.

10. The MEA structure of claim 1, wherein the subgasket material is thermally curable in situ.

11. The MEA structure of claim 1, wherein the subgasket material is curable by chemical crosslinking.

12. The MEA structure of claim 1, wherein the subgasket material is depositable by screen printing.

13. The MEA structure of claim 1, wherein the subgasket material is depositable by coating.

14. The MEA structure of claim 1, wherein the subgasket material is depositable by spraying.

15. The MEA structure of claim 1, wherein the subgasket material is depositable by ink jet printing.

16. The MEA structure of claim 1, wherein the subgasket is dimensioned to overlap an active area of the MEA structure.

17. The MEA structure of claim 1, wherein the subgasket is dimensioned to avoid overlapping an active area of the MEA structure.

18. The MEA structure of claim 1, wherein the subgasket has a thickness of about 5 μm to about 100 μm.

19. The MEA structure of claim 1, wherein the subgasket comprises a pressure sensitive adhesive composition.

20. The MEA structure of claim 1, wherein the subgasket comprises a thermoplastic material.

21. The MEA structure of claim 1, wherein the subgasket comprises an ionically nonconductive material.

22. The MEA structure of claim 1, wherein the subgasket comprises an electrically nonconductive material.

23. The MEA structure of claim 1 wherein a surface of the subgasket comprises a sealing surface.

24. The MEA structure of claim 23, wherein the sealing surface comprises a microstructured surface.

25. A membrane electrode assembly (MEA), comprising:
a first membrane electrode structure; and
a second membrane electrode structure coupled to the first membrane electrode structure, at least one of the first and second membrane electrode structures having components, comprising:
an electrode subassembly having components, comprising:
a polymer electrolyte membrane;
a gas diffusion layer; and
a catalyst layer between the polymer electrolyte membrane and the gas diffusion layer; and
a subgasket disposed over one or more components of the electrode subassembly, a peripheral edge of the gas diffusion layer overlapping the subgasket, the subgasket comprising a layer of material that is depositable and curable in situ.

26. The MEA of claim 25, wherein the subgasket is disposed over a peripheral portion of the polymer electrolyte membrane.

27. The MEA of claim 25, wherein a portion of the subgasket is disposed between the catalyst layer and the polymer electrolyte membrane.

28. The MEA of claim 25, wherein a portion of the subgasket is disposed between the catalyst layer and the gas diffusion layer.

29. The MEA of claim 25, wherein the gas diffusion layer and the catalyst layer form a catalyst coated electrode backing and an edge of the catalyst coated electrode backing overlaps the subgasket.

30. The MEA of claim 25, wherein the polymer electrolyte membrane and the catalyst layer form a catalyst coated membrane and the subgasket is disposed over a peripheral portion of the catalyst coated membrane.

31. The MEA of claim 25, wherein the peripheral edge of the gas diffusion layer overlaps the subgasket by about 0.05 mm to about 10 mm.

32. The MEA of claim 25, wherein the second membrane electrode structure and the first membrane electrode structure are coupled by a fused bilayer polymer electrolyte membrane.

33. The MEA of claim 25, wherein:
the subgasket is disposed over a peripheral portion of the polymer electrolyte membrane; and
the second membrane electrode structure and the first membrane electrode structure are coupled by a fused bilayer polymer electrolyte membrane having a fused internal subgasket.

34. The MEA of claim 25, wherein the subgasket material is curable in situ by radiation.

35. The MEA of claim 25, wherein the subgasket material is curable by chemical crosslinking.

36. The MEA of claim 25, wherein the subgasket material is depositable by screen printing.

37. The MEA of claim 25, wherein the subgasket material is depositable by coating.

38. The MEA of claim 25, wherein the subgasket material is depositable by spraying.

39. The MEA of claim 25, wherein the subgasket material is depositable by ink jet printing.

40. The MEA of claim 25, wherein the subgasket is dimensioned to overlap an active area of the electrode subassembly.

41. The MEA of claim 25, wherein the subgasket is dimensioned to avoid overlapping an active area of the electrode subassembly.

42. The MEA of claim 25, wherein the subgasket has a thickness of about 5 μm to about 100 μm.

43. The MEA of claim 25, wherein the subgasket comprises an ionically nonconductive material.

44. The MEA of claim 25, wherein the subgasket comprises an electrically nonconductive material.

45. The MEA of claim 25, wherein a surface of the subgasket comprises a sealing surface.

46. The MEA of claim 45, wherein the sealing surface comprises a microstructured surface.

47. An electrochemical cell assembly, comprising:
a membrane electrode assembly (MEA) having components, comprising:
a polymer electrolyte membrane;
first and second gas diffusion layers disposed at opposite surfaces of the polymer electrolyte membrane; and
first and second catalyst layers, the first catalyst layer disposed between the first gas diffusion layer and the polymer electrolyte membrane and the second catalyst layer disposed between the second gas diffusion layer and the polymer electrolyte membrane; and
a subgasket formed of one or more layers of material that is depositable and curable in situ, a portion of the subgasket disposed between the first and second gas diffusion layers.

48. The assembly of claim 47, wherein the subgasket layers are disposed over a peripheral portion of the polymer electrolyte membrane.

49. The assembly of claim 47, wherein the first gas diffusion layer and the first catalyst layer form a first catalyst coated electrode backing, the second gas diffusion layer and the second catalyst layer form a second catalyst coated electrode backing and the portion of the subgasket is disposed between the first catalyst coated electrode backing and the second catalyst coated electrode backing.

50. The assembly of claim 47, wherein the polymer electrolyte membrane and the first and second catalyst layers form a catalyst coated membrane and the subgasket is disposed over a peripheral portion of the catalyst coated membrane.

51. The assembly of claim 47, wherein the subgasket material is curable in situ by radiation.

52. The assembly of claim 51, wherein the radiation comprises ultraviolet radiation.

53. The assembly of claim 47, wherein the subgasket material is thermally curable in situ.

54. The assembly of claim 47, wherein the subgasket material is curable by chemical crosslinking.

55. The assembly of claim 47, wherein the subgasket material is depositable by at least one of screen printing, coating, spraying and ink jet printing.

56. The assembly of claim 47, wherein the subgasket is dimensioned to overlap an active area of the MEA.

57. The assembly of claim 47, wherein the subgasket is dimensioned to avoid overlapping an active area of the MEA.

58. The assembly of claim 47, wherein the subgasket has a thickness of about 5 μm to about 100 μm.

59. The assembly of claim 47, wherein the subgasket comprises an ionically nonconductive material.

60. The assembly of claim 47, wherein the subgasket comprises an electrically nonconductive material.

61. The assembly of claim 47, wherein a surface of the subgasket comprises a sealing surface.

62. The assembly of claim 61, wherein the sealing surface comprises a microstructured surface.

63. A method for making a membrane electrode assembly (MEA), comprising:
forming one or more subgasketed MEA components, comprising:
depositing a dispersable subgasket material over a portion of at least one surface of one or more MEA components;
curing the subgasket dispersion material in situ to form one or more subgasket layers;
aligning first and second gas diffusion layer (GDL) structures at opposite surfaces of a polymer electrolyte membrane (PEM) structure so that portions of the subgasket layers are disposed between the first and the second GDL structures, wherein one or more of the first GDL structure, the second GDL structure and the PEM structure comprises the one or more subgasketed MEA components.

64. The method of claim 63, wherein forming the one or more subgasketed MEA components comprises forming a subgasketed PEM structure.

65. The method of claim 63, wherein forming the one or more subgasketed MEA components comprises forming one or more subgasketed GDL structures.

66. The method of claim 63, wherein the PEM structure comprises a catalyst coated membrane.

67. The method of claim 63, wherein the first and second GDL structures comprise catalyst coated electrode backings.

68. The method of claim 63, wherein depositing the dispersable subgasket material comprises screen printing the dispersable subgasket material.

69. The method of claim 63, wherein depositing the dispersible subgasket material comprises coating the dispersible subgasket material.

70. The method of claim 63, wherein depositing the dispersible subgasket material comprises spraying the dispersible subgasket material.

71. The method of claim 63, wherein depositing the dispersible subgasket material comprises ink jet printing the dispersible subgasket material.

72. The method of claim 63, wherein curing the dispersable subgasket material in situ comprises curing the subgasket dispersion material in situ by exposure to moisture.

73. The method of claim 63, wherein curing the dispersable subgasket material in situ comprises curing the subgasket dispersion material in situ by exposure to a gas.

74. The method of claim 63, wherein curing the dispersable subgasket material in situ comprises curing the subgasket dispersion material in situ by exposure to radiation.

75. The method of claim 63, wherein curing the subgasket dispersion material in situ comprises thermally curing the subgasket dispersion material in situ.

76. The method of claim 63, wherein curing the subgasket dispersion material in situ comprises curing the subgasket dispersion material in situ by cooling the dispersable subgasket material.

77. The method of claim 63, wherein curing the subgasket dispersion material in situ comprises chemically altering the subgasket dispersion material.

78. The method of claim 63, wherein curing the subgasket dispersion material in situ comprises curing without chemically altering the subgasket dispersion material.

79. The method of claim 63, further comprising bonding the first and second GDL structures to the PEM structure.

80. The method of claim 79, wherein bonding the first and second GDL structures to the PEM structure comprises applying one or both of pressure and heat to the first and second GDL structures and the PEM structure.

81. The method of claim 80, wherein applying one or both of pressure and heat to the first and second GDL structures and the PEM structure comprises applying pressure at about 0.5 tons to about 3.0 tons per 50 cm2.

82. The method of claim 80, wherein applying one or both of pressure and heat to the first and second GDL structures and the PEM structure comprises applying heat at a temperature near the softening point of the PEM.

83. The method of claim 80, wherein bonding the first and second GDL structures to the subgasketed PEM comprises applying one or both of pressure and heat to the first and second GDL structures and the PEM structure for a predetermined period of time.

84. The method of claim 83, wherein the predetermined period of time comprises about 10 minutes or less.

85. The method of claim 63, wherein:
forming the one or more subgasketed MEA components comprises forming a subgasketed PEM structure; and
disposing the first and second GDL structures at the opposite surfaces of the subgasketed PEM structure comprises:
cutting the first and second GDL structures from a larger sheet; and
aligning the first and second GDL structures in relation to the opposite surfaces of the subgasketed PEM structure.

86. The method of claim 63, wherein:
forming the one or more subgasketed MEA components comprises forming a subgasketed PEM structure; and
aligning the first and second GDL structures in relation to the opposite surfaces of the subgasketed PEM structure comprises aligning the first and second GDL structures to overlap a subgasketed portion of the subgasketed PEM structure.

87. A method for making a membrane electrode (MEA) subassembly including a gas diffusion layer (GDL) structure and a polymer electrolyte membrane (PEM) structure, the method comprising:
forming a subgasketed MEA component, comprising:
depositing a dispersable subgasket material over a portion of at least one surface of an MEA component;
curing the subgasket dispersion material in situ to form one or more subgasket layers;
disposing the GDL structure over the PEM structure so that an edge of the GDL structure overlaps a portion of the one or more subgasket layers, wherein at least one of the GDL and the PEM comprise the one or more subgasketed MEA components.

88. The method of claim 87, wherein forming the subgasketed MEA component comprises forming a subgasketed PEM.

89. The method of claim 87, wherein forming the subgasketed MEA component comprises forming a subgasketed GDL.

90. The method of claim 87, wherein forming the subgasketed MEA component comprises forming a subgasketed catalyst coated membrane.

91. The method of claim 87, wherein forming the subgasketed MEA component comprises forming a subgasketed catalyst coated electrode backing.

92. The method of claim 87, further comprising disposing the GDL structure over one surface of the PEM structure and disposing an opposing GDL structure over an opposite surface of the PEM structure.
